(19) United States
(12) Patent Application Publication
(10) Pub. No.: US 2004/0024166 A1
(43) Pub. Date: Feb. 5, 2004

(54) Conductive urethane composition, conductive roller composed of conductive urethane composition

(76) Inventors: Takayuki Hattori, Hyogo (JP); Tetsuo Mizoguchi, Hyogo (JP); Yoshihisa Mizumoto, Hyogo (JP); Shinichi Murakami, Hyogo (JP); Fumihiko Noda, Hyogo (JP); Tsutomu Tokushige, Hyogo (JP)

Correspondence Address: BIRCH STEWART KOLASCH & BIRCH, PO BOX 747, FALLS CHURCH, VA, 22040-0747, US

(21) Appl. No.: 10/629,756

(22) Filed: Jul. 30, 2003

(30) Foreign Application Priority Data
Aug. 1, 2002 (JP) 2002-224920

(51) Int. Cl. C08G 18/10

(52) U.S. Cl. 528/66

(57) ABSTRACT

In a conductive urethane composition including polyurethane obtained by a poly-addition reaction of polyol and polyisocyanate, polyether polyol is used as the polyol. An average value of a non-saturation degree of the polyether polyol is set to not more than 0.025 milliequivalents/g. The conductive urethane composition contains an organic ionic-conductive agent such as organometallic salts having fluoro groups and/or sulfonyl groups.

### BACKGROUND OF THE INVENTION

1. Field of the Invention

The present invention relates to a conductive urethane composition, a conductive roller composed of the conductive urethane composition. More particularly, the present invention is intended to improve the mixing composition of the urethane composition that can be effectively used for conductive rollers such as the charging roller, the developing roller, a toner supply roller, and the transfer roller of a copying machine, a printer, and the like to allow the conductive urethane composition and the rollers to have a low electric resistance and superior properties.

2. Description of the Related Art

It is necessary that the charging roller, the developing roller, the toner supply roller, the transfer roller, and the transfer belt for use in the copying machine, the printer, and the like have an appropriate stable electric resistance value. To impart conductivity to the roller and the belt of this kind, the following two methods are used: In one method, an electroconductive rubber containing a conductive filler such as powder of metal oxide and carbon black is used. In the other method, an ionic-conductive rubber such as urethane rubber, acrylonitrile butadiene rubber (NBR) or epichlorohydrin rubber is used.

The electric resistance value of the conductive roller or the conductive belt composed of the electroconductive rubber containing the conductive filler depends on an applied voltage and does not have a constant electric resistance value. In the case where the carbon black is used as the conductive filler, there is no stable correlation between the addition amount of the carbon black and the volume specific resistance of the rubber. Moreover as described above, in a region, the electric resistance changes rapidly owing to a slight change of the addition amount of the carbon black. Therefore it is very difficult to control the electric resistance value.

In addition, because it is difficult to disperse the conductive filler uniformly in the rubber, the electric resistance value has variations in the circumferential and widthwise directions of the roller and the belt. Even though a large variation of the electric resistance value is reduced, the electric resistance value has variations in a minute range as small as a μm order. Recently, a high-image quality is provided by using digital image processing technique and color image processing technique. Thus the ionic-conductive elastomer is used in preference over the electroconductive elastomer.

As the method of forming the ionic-conductive rubber, various proposals have been made. For example, in a proposal, a conductive oligomer (Mn is less than 10000) such as polyethylene oxide containing the polyether structure and a conductive plasticizer (Mn is less than 10000) are used. In another proposal, acrylonitrile-butadiene rubber (NBR), urethane rubber or epichlorohydrin rubber is singly used or a mixture of one of these rubbers and other materials is used.

For example, in Japanese Patent Application Laid-Open No. 9-34215, there is proposed the conductive roller containing a conductive elastic layer composed of polyurethane elastomer obtained by reaction and hardening of a reactive mixture containing polyisocyanate, polyol, and a conductivity-imparting agent under the presence of a catalyst of diazabicyclo amine salt.

In Japanese Patent Application Laid-Open No. 11-52712, there is proposed the conductive roller, for an electrophotographic apparatus, having a conductive elastic layer composed of polyurethane obtained by reaction and hardening of a mixture of polypropylene ether polyol having molecular end at which an average ethylene oxidation percentage is not less than 10, polyisocyanate, a conductivity-imparting agent, and a catalyst.

However, the ionic-conductive rubber composed of the conductive agent bleeds or blooms and is liable to stain a photosensitive member.

In the ionic-conductive rubber containing acrylonitrile butadiene rubber (NBR) or urethane rubber, it is difficult to reduce the volume specific resistance value without deteriorating the properties (compression set and hardness) thereof. To maintain the properties of the ionic-conductive rubber, the ionic-conductive rubber has a comparatively high resistance value unavoidably. Thus it is difficult to use a transfer belt or a transfer roller of the ionic-conductive rubber for a copying machine, a printer, and the like required to have a comparatively low electric resistance value. The electric resistance value of the ionic-conductive rubber containing NBR, urethane rubber or epichlorohydrin rubber depends greatly on environment. In the case where conductive members such as a conductive roller composed of the ionic-conductive rubber are used for a copying machine, a printer, and the like, it is necessary to mount a large power source for controlling the conductive members. Consequently the copying machine, the printer, and the like cost high.

Urethane elastomer has a low compression set but has a low hardness and is incapable of realizing a low electric resistance value. Thermoplastic urethane has a high compression set and a high hardness. Further the electric resistance value of the thermoplastic urethane depends greatly on environment. Therefore it is difficult to use the thermoplastic urethane for the conductive roller and the like.

The conductive roller disclosed in Japanese Patent Application Laid-Open No. 9-34215 and the conductive roller for the electrophotographic apparatus disclosed in Japanese Patent Application Laid-Open No11-52712 are capable of staining the photosensitive member to a lower extent. However, when a roller having a low electric resistance is realized, the roller may stain the photosensitive member to a high extent. As described above, it is difficult to reduce the electric resistance of the roller without deteriorating various properties thereof.

### SUMMARY OF THE INVENTION

The present invention has been made in view of the above-described problems. Therefore it is an object of the present invention to provide a conductive urethane composition that has a low electric resistance value, allows the electric resistance value to have a low extent of dependency on environment, has preferable properties (low compression set and hardness), does not stain a photosensitive member. It is another object of the present invention to provide a conductive roller, composed of the conductive urethane composition, having superior durability and size stability.

To achieve the object, according to the present invention, there is provided a conductive urethane composition including polyurethane obtained by a poly-addition reaction of polyol and polyisocyanate. Polyether polyol is used as the polyol. An average value of a non-saturation degree of the polyether polyol is set to not more than 0.025 milliequivalents/g.

By using the polyether polyol having a low degree of non-saturation, it is possible to reduce the amount of monool that remain non-crosslinked, prevent the conductive urethane composition from being tacky, and realize a low extent of stain on a photosensitive member. Therefore the use of the polyether polyol allows reduction of the compression set, the hardness, the electric resistance of the conductive urethane composition, and the degree of dependency of the electric resistance value on environment.

The reason the average value of the non-saturation degree of the polyether polyol contained in the conductive urethane composition as the polyol is set to not more than 0.025 milliequivalents/g is as follows: If the average value of the non-saturation degree of the polyether polyol is more than 0.025 milliequivalents/g, a photosensitive member is stained, and the conductive urethane composition is tacky.

The average value of the non-saturation degree of the polyether polyol is favorably not more than 0. 015 milliequivalents/g (meq/g) and more favorably not more than 0.010 milliequivalents/g (meq/g). The smaller the non-saturation degree is, the better.

It is preferable that the polyether polyol is produced by using a double metal cyanide catalyst to set the average value of the non-saturation degree thereof to not more than 0.025 milliequivalents/g. Thereby the polyether polyol containing a small amount of the monool can be easily produced. A known method can be used to produce the polyether polyol by using the double metal cyanide catalyst.

It is preferable that the conductive urethane composition of the present invention has a compression set not more than 15% when it is measured at 70° C. for 24 hours in a permanent set testing methods for rubber, vulcanized or themoplastic specified in JIS K6262.

If the conductive urethane composition has a compression set more than 15%, a conductive roller composed of the conductive urethane composition has a large dimensional change and cannot be put into practical use. When the conductive urethane composition is formed as a blowing (sponge), there is some difference in the compression set in dependence on a blowing magnification and a blowing mode. However, the value of the compression set of the blowing is favorably not more than 15%, more favorably not more than 10%, and most favorably not more than 5%.

It is favorable that the conductive urethane composition of the present invention has a volume resistivity less than 10^{9.0} (Ω·cm) when the volume resistivity is measured at an applied voltage of 500V in the method specified in JIS K6911. If the volume resistivity of the conductive urethane composition is not less than 10^{9.0} (Ω·cm), the conductive roller and the conductive belt composed of the conductive urethane composition have a low efficiency in toner-image transfer, charging, and toner supply operations. Thus the conductive roller and the conductive belt cannot be put into practical use. It is more favorable that the volume resistivity of the conductive urethane composition is not less than 10^{6.0} (Ω·cm) nor more than 10^{8.0} (Ω·cm).

The volume specific resistance value (volume resistivity) specified in JIS K6911 is measured at a constant temperature of 23° C., a constant relative humidity of 55%, and an applied voltage of 500V. The dependency Δlog₁₀ρᵥ of the volume specific resistance value on environment is computed by using an equation described later. It is favorable that the dependency Δlog₁₀ρᵥ of the volume specific resistance value on environment is less than 1.0, more favorably less than 0.8 and most favorably less than 0.6.

It is favorable that the hardness of the conductive urethane composition of the present invention is not more than 55 degrees when the hardness is measured in accordance with a durometer hardness test type A specified in JIS K-6253. This is because the softer the conductive urethane composition is, the larger the nip is. Consequently the conductive urethane composition increases efficiency in the toner-image transfer, charging, and developing operations and decreases the extent of mechanical damage to members such as the photosensitive member of a copying apparatus and the like. It is more favorable that the hardness of the conductive urethane composition is set to not less than 30 degrees nor more than 45 degrees.

It is preferable that the conductive urethane composition of the present invention contains an organic ionic-conductive agent other than ammonium salts containing chlorine or bromine to set the volume resistivity of the conductive urethane composition to not more than 10^{8.0} (Ω·cm).

The conductive urethane composition containing the organic ionic-conductive agent is capable of efficiently realizing a low hardness, a low electric resistance, a low compression set, and a low extent of stain onto a photosensitive member. By appropriately selecting the kind of the organic ionic-conductive agent, it is possible to reduce the degree of dependency of the electric resistance value on environment.

It is preferable that the organic ionic-conductive agent consists of organometallic salts having fluoro groups and/or sulfonyl groups.

It is preferable that the organometallic salts having the fluoro groups and/or the sulfonyl groups consist of metal salts of bis(fluoroalkyl-sulfonyl)imide and/or metal salts of fluoroalkyl sulfonic acid. Thereby without deteriorating various properties of the conductive urethane composition, it is possible to greatly reduce the volume specific resistance value of the conductive urethane composition containing a very small amount of the organometallic salt having the fluoro groups and/or the sulfonyl groups and also the degree of the dependency of the volume specific resistance value on environment. To reduce an equal electric resistance value of the conductive urethane composition, the addition amount of the metal salts of the bis(fluoroalkyl-sulfonyl)imide is smaller than that of the metal salts of the fluoroalkyl sulfonic acid. Further the metal salts of the bis(fluoroalkyl-sulfonyl)imide deteriorate the properties, for example, the hardness and compression set of the conductive urethane composition to a lower extent than the metal salts of the fluoroalkyl sulfonic acid. Furthermore the metal salts of the bis(fluoroalkyl-sulfonyl)imide are capable of reducing the dependency of the electric resistance value of the conductive urethane composition on environment to a higher extent than the metal salts of the fluoroalkyl sulfonic acid.

Because the metal salts of the bis (fluoroalkyl-sulfonyl) imide or the metal salts of the fluoroalkyl sulfonic acid have a high electron attraction effect, localization of the electric charge thereof is prevented. Thus the metal salts of the bis (fluoroalkyl-sulfonyl) imide or the metal salts of the fluoroalkyl sulfonic acid are capable of displaying a high solubility and a high salt dissolution degree for polymeric chains of polyether, showing a high electrochemical stability, realizing a high ionic conductivity, and reducing the degree of the dependency of the electric resistance value on environment. The addition of the organometallic salt containing the fluoro groups and/or the sulfonyl groups allows realization of an efficient reduction of the electric resistance of the conductive urethane composition. Therefore by appropriately adjusting the use amount of the polymer component, the conductive urethane composition is capable of keeping a low electric resistance and reducing the degree of the dependency of the volume resistivity value on environment. Further the conductive member such as the conductive roller stains the photosensitive member to a lower extent.

Lithium salts are preferable as the organometallic salt. In addition, alkaline metal salts, salts of group 2A metals or other metals may be used as the organometallic salt.

More specifically, the following organometallic salts can be used: LiCF₃SO₃, LiN(SO₂CF₃) 2, LiC(SO₂CF₃)3, LiCH(SO₂CF₃)₂, LiSF₅CF₂SO₃, and Li[(OCH(CF₃)₂) 6Nb]. It is preferable that any of these organometallic salts is uniformly dispersed in the conductive urethane composition.

The organometallic salts can be produced by a known method.

In addition to the above-described organometallic salts, it is possible to provide the conductive urethane composition with preferable property and the effect of reducing its electric resistance greatly by using other organic ionic-conductive agents or using them in combination. For example, as the other organic ionic-conductive agents, quaternary ammonium salts are preferable. Quaternary ammonium salts not containing halogen can be preferably used. The quaternary ammonium salts not containing chlorine are particularly useful because they prevent deterioration of the compression set of the conductive urethane composition and increase of its hardness.

As the quaternary ammonium salts not containing halogen, salts of comparatively strong acids such as quaternary ammonium salts of sulfonic acid and quaternary ammonium salts of glucono-lactone can be preferably used. Because these quaternary ammonium salts have a high ionization degree, they realize a low electric resistance efficiently, a low compression set, and a low extent of stain onto the photosensitive member.

It is favorable that not less than 0.5% of the organometallic salt is single-ionized. Thereby it is possible to allow the conductive urethane composition to have a stable conductivity to a higher extent. The addition of a small amount of the metal salt provides the conductive urethane composition with a low electric resistance value. It is more favorable that not less than 1% of the organometallic salt nor more than 20% thereof is single-ionized.

Single ionization means a phenomenon that an ion adsorbent adsorbs positive ions or negative ions generated by dissociation of the organometallic salt to thereby allow non-adsorbed ions to move alone comparatively freely in a composition.

Positive ions stabilized by polyether contribute to conductivity of the conductive urethane composition of the present invention. Thus in the present invention, it is preferable that a negative ion adsorbent adsorbs negative ions to thereby single-ionize the organometallic salt.

As the negative ion adsorbent, it is possible to use inorganic composite salts such as hydrotalcites, zeolites, and the like.

It is preferable that the polyether polyol contains ethylene oxide and/or propylene oxide at not less than 50 wt %. In the case where the ethylene oxide (EO) is present at the end of the polyether polyol, the polyether polyol has primary hydroxyl groups and has a high reactivity. Thus the polyether polyol has an advantage of realizing a low extent of stain onto the photosensitive member and reducing the degree of adhesiveness of the conductive urethane composition.

By using the polyether polyol, it is possible to stabilize metal cations or oxonium ions and provides the conductive urethane composition with a lower electric resistance value. In an ionic conductivity, the metal cations or the oxonium ions are transported owing to a segment motion of polymer chains having ethylene oxide units or propylene oxide units and the electric charge moves. As a result, the electric resistance value of the conductive urethane composition becomes low. It is preferable that the polyether polyol has two or more hydroxyl groups.

The polyether polyol has polypropylene glycol as the base thereof.

In this case, it is possible to supply the conductive urethane composition having a low electric resistance value at a comparatively low cost.

As components of the polyether polyol, it is possible to use polyethylene glycol, polytetramethylene glycol, and derivatives thereof in addition to the polypropylene glycol.

As the polyisocyanate, it is possible to use known isocyanates: tolylene di-isocyanate (TDI), monomeric MDI (MMDI), polymeric MDI (PMDI), xylylene di-isocyanate (XDI), hexamethylene di-isocyanate (HDI), isophorone di-isocyanate (IPDI); modified substances formed by reaction of these isocyanates; and mixtures of these isocyanates.

It is favorable to use not less than 0.01 parts by weight of an organic ionic-conductive agent such as the organometallic salt nor more than 5.0 parts by weight thereof for 100 parts by weight of the polyol.

If the conductive urethane composition contains less than 0.01 parts by weight of the organic ionic-conductive agent for 100 parts by weight of the polyol, there is little effect of using the organic ionic-conductive agent. On the other hand, if the conductive urethane composition contains more than 5.0 parts by weight of the organic ionic-conductive agent for 100 parts by weight of the polyol, the electric resistance value of the conductive urethane composition changes little and the material cost becomes high. Further the organometallic salt may bloom from the surface of the conductive urethane composition.

It is more favorable to use not less than 0.1 parts by weight of the organic ionic-conductive agent nor more than 2.5 parts by weight thereof and more favorable to use not less than 0.25 parts by weight thereof nor more than 1.5 parts by weight thereof for 100 parts by weight of the polyol.

It is preferable that the amount of the polyisocyanate to be used for 100 parts by weight of the polyol is set in such a way that an isocyanate index (molar ratio of NCO group to OH group) is 100 to 110.

If the isocyanate index is less than 100, a large number of ends of the hydroxyl group of the polyol remain unreacted and a large number of the polyols remain non-crosslinked. Consequently the conductive urethane composition is tacky, and the conductive member such as the conductive roller composed of the conductive urethane composition is liable to stain the photosensitive member. If the isocyanate index is more than 110, excess isocyanate is liable to make a secondary reaction.

It is preferable to use not less than 0.01 parts by weight of an isocyanate hardening reaction catalyst nor more than 0.8 parts by weight thereof for 100 parts by weight of the polyol.

As the isocyanate hardening reaction catalyst, it is possible to use salts such as 1,8-diazobicyclo(5,4,0) undecen-7 (DBU), 1,5-diazobicyclo-(4,3,0)-nonene-5 (DBN).

The conductive urethane composition of the present invention can be produced by known methods. For example, the conductive urethane composition can be produced by one-shot method and a prepolymer method.

A conductive elastic cylindrical body is formed of the conductive urethane composition of the present invention. Thereafter a metal shaft is mounted on the cylindrical body. Thereby a conductive roller is formed.

Because the conductive urethane composition of the present invention has a low compression set, it is excellent in its dimensional accuracy and contributes to formation of a favorable image over a long period of time. Because the conductive urethane composition is ionic-conductive, there are few variations between products in the quality thereof. Further because the conductive urethane composition has a low hardness, it is possible to allow the nip width to be large. Therefore it is possible to perform toner-image transfer, charging, and developing operations with high efficiency and minimize mechanical damages to members such as the photosensitive member of a copying machine and the like. Further it is possible to reduce the degree of the dependency of the electric resistance value of the conductive urethane composition on environment and the degree of stain onto the photosensitive member. That is, the conductive roller composed of the conductive urethane composition has very high performance.

It is preferable that the peripheral surface of the metal shaft is treated with plasma, and the peripheral surface of the metal shaft and the inner peripheral surface of the cylindrical body are bonded to each other.

It is possible to improve the adhesive force easily by treating the peripheral surface of the metal shaft with plasma. Depending on a case, the shaft can be mounted on the cylindrical roller without using an adhesive agent.

Preferable adhesive property can be obtained by a connection between isocyanate added to the material of the conductive urethane composition of the present invention and hydroxyl groups generated on the surface of the metal shaft by the plasma treatment. Thus it is possible to form the conductive roller by selecting a suitable plasma treatment condition and a proper kind of metal for the shaft, even though the adhesive agent is not used.

In the case where the conductive roller is formed without using the adhesive agent, it is unnecessary to apply the adhesive agent to the surface of the metal shaft. In the case where the adhesive agent is applied to the surface of the metal shaft, irregularities are liable to be generated on the surface thereof owing to nonuniform application of the adhesive agent and further the electric resistance is liable to be nonuniform. On the other hand, in the case where the adhesive agent is not applied to the surface thereof, irregularities are difficult to be formed on the surface thereof. Thus in the case where the surface of the conductive roller is polished after casting is performed, it is possible to make the polished surface smooth. Thereby the conductive roller is optimum as the developing roller required to have high surface precision.

As described above, the present invention provides the conductive roller suitable for the toner-image transfer, charging, and developing operations to be performed in a conductive mechanism of an electrophotographic apparatus such as a copying machine, a printer, and the like by appropriately setting the compression set, the volume resistivity, and the hardness of the conductive urethane composition. More specifically, the conductive roller can be suitably used as the charging roller for charging the photosensitive member uniformly, the developing roller for attaching toner to the photosensitive member, and the transfer roller for transferring a toner image to paper or an intermediate transfer belt from the photosensitive member. It is possible to compose a conductive belt of the conductive urethane composition of the present invention.

### BRIEF DESCRIPTION OF THE DRAWINGS

FIG. 1 is a schematic view showing a conductive roller of the present invention.

FIG. 2 shows a method of measuring an electric resistance of the conductive roller.

### DETAILED DESCRIPTION OF THE PREFERRED EMBODIMENTS

The embodiments of the present invention will be described below with reference to the drawings.

The conductive urethane composition of the first embodiment of the present invention contains polyurethane obtained by a poly-addition reaction of polyol and polyisocyanate.

The polyol contains polypropylene glycol as its base. The average value of the non-saturation degree of the polyol is 0.007 milliequivalents/g. As the polyol, 100 parts by weight of polyether polyol consisting of ethylene oxide and/or propylene oxide is used.

The polyisocyanate contains 8.0 parts by weight of a modification of 4,4′-diphenylmethane di-isocyanate (MDI) containing polymeric MDI.

As the organometallic salt containing fluoro groups and/or sulfonyl groups, 0.5 parts by weight of lithium-bis (trifluoromethylsulfonyl)imide is used. An isocyanate hardening reaction catalyst is also used as a component of the conductive urethane composition.

The conductive urethane composition has a compression set of 3% when the compression set is measured at 70 C for 24 hours in a permanent set testing methods for rubber, vulcanized or thermoplastic specified in JIS K6262; a volume resistivity of 10^{7.3} (Ω·cm) when the volume resistivity is measured at an applied voltage of 500V in the method specified in JIS K6911; and a hardness of 38 degrees when the hardness is measured in accordance with the durometer hardness test type A specified in JIS K-6253.

The method of producing a conductive roller composed of the conductive urethane composition is described below.

The conductive agent is dispersedly dissolved in the polyether polyol. Thereafter a curing catalyst is put into the solution of the conductive agent and the polyether polyol. The solution is stirred to uniformly disperse the curing catalyst therein. The solution and isocyanate are dried respectively by suction drying with a vacuum pump to remove water.

Both solutions prepared by the above-described method are carefully stirred in a container with a general-purpose stirrer in such a way as not to generate bubbles. The mixture of the two solutions is cast into a die for forming a roller.

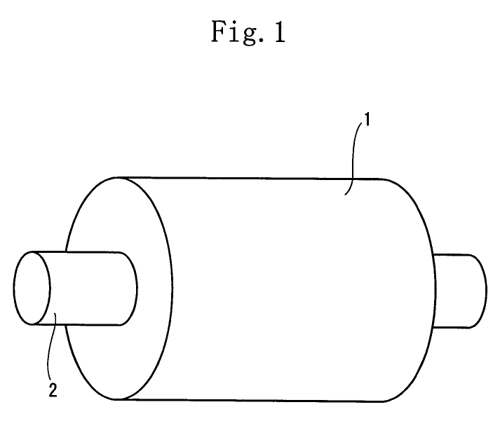

A metal shaft 2 which has undergone primer treatment for urethane is set in the die in which the mixture of the two solutions have been cast carefully in such a way as not to generate bubbles. After the die is heated at 80° C. for 30 minutes, the roller and the shaft are removed therefrom. Then the surface of the roller is polished. The axial end of the roller is cut to finish it to a predetermined dimension. Thereby as shown in FIG. 1, a shaft-mounted cylindrical conductive roller 1 is obtained.

By using the polyether polyol containing a small amount of the monool, it is possible to obtain a conductive roller that does not stain the photosensitive member, is low in its compression set and hardness, and is excellent in its dimensional stability and durability, although it has a low volume resistivity. Further it is possible to reduce the volume resistivity of the conductive urethane composition efficiently by using a small amount of the organometallic salt. By appropriately selecting the kind of organometallic salt, it is possible to reduce the dependency of the electric resistance value of the conductive urethane composition on environment.

By appropriately selecting the addition amount of the components of the conductive urethane composition of the present invention, the conductive urethane composition can be used as conductive rollers such as the transfer roller, the charging roller, the developing roller, and the toner supply roller. The conductive urethane composition may contain blowing agents to form a blowing roll. The conductive belt can be composed of the conductive urethane composition.

In the first embodiment, the shaft is mounted on the roller by using the primer. It is possible to bond the peripheral surface of the metal shaft and the inner peripheral surface of the roller to each other with a high adhesive force by casting the material for the roller into the die in which the metal shaft whose surface has been treated by plasma is set. Depending on a case, the metal shaft can be mounted on the roller without using the primer.

The example of the conductive urethane composition of the present invention and the comparison example will be described in detail below.

Using the materials composed of the components shown in table 1 through 3, property evaluation slab sheets and specimens of examples 1 through 6 and comparison examples 1 through 6 were prepared.

TABLE 1

| Chemicals | Commercial name | Maker | Details of chemicals | E1 | E2 | E3 | E4 | E5 | E6 |
|---|---|---|---|---|---|---|---|---|---|
| Polyether | | Bayer | Polypropylene | 50 | 50 | 50 | 50 | 50 | 50 |
| polyol 1 | | A.G. | glycol(PPG) base, | | | | | | |
| | | | Bifunctional, | | | | | | |
| | | | Molecular weight: | | | | | | |
| | | | 4000, | | | | | | |
| | | | non-saturation | | | | | | |
| | | | degree: 0.007 meq/g | | | | | | |
| Polyether | | Bayer | PPG base, | 50 | 50 | 50 | 50 | 50 | 50 |
| polyol 2 | | A.G. | Trifunctional, | | | | | | |
| | | | Molecular weight: | | | | | | |
| | | | 6000, | | | | | | |
| | | | non-saturation | | | | | | |
| | | | degree: 0.007 meq/g | | | | | | |
| Polyether | | Sumika | PPG base, | | | | | | |
| polyol 3 | | Bayer | Bifunctional, | | | | | | |
| | | Urethane | Molecular weight: | | | | | | |
| | | | 4000, | | | | | | |
| | | | non-saturation | | | | | | |
| | | | degree: 0.048 meq/g, | | | | | | |
| | | | Hydroxyl | | | | | | |
| | | | value = 28 mgKOH/g | | | | | | |
| Polyether | | Sumika | PPG base, | | | | | | |
| polyol 4 | | Bayer | Trifunctional, | | | | | | |
| | | Urethane | Molecular weight: | | | | | | |
| | | | 4800, | | | | | | |
| | | | non-saturation | | | | | | |
| | | | degree: 0.048 meq/g, | | | | | | |
| | | | Hydroxyl | | | | | | |
| | | | value = 35 mgKOH/g | | | | | | |
| Conductive | Lithium salt of | Sanko | | 0.5 | 1.0 | 0.0 | | | 0.5 |
| agent 1 | bis(trifluoromethylsulfonyl) | Chemical | | | | | | | |
| | imide | Industry | | | | | | | |
| Conductive | Lithium salt of | Sanko | For single | | | | 0.5 | | |
| agent 2 | trifluoromethylsulfonic | Chemical | ionization, | | | | | | |
| | acid | Industry | negative ion | | | | | | |
| | | | adsorbent adsorbs | | | | | | |
| | | | 10% of negative ions | | | | | | |
| Conductive | Lithium salt of | Sanko | Used without single | | | | | 0.5 | |
| agent 3 | trifluoromethylsulfonic | Chemical | ionization | | | | | | |
| | acid | Industry | | | | | | | |
| Isocyanate | SBUisocyanate-0389 | Sumika | Mixture of | 8.0 | 8.0 | 8.0 | 8.0 | 8.0 | 8.0 |
| 1 | | Bayer | bifunctional | | | | | | |
| | | Urethane | modificated | | | | | | |
| | | | MDI + polymericMDI | | | | | | |
| isocyanate | U-CAT SA102 | San-apro | Salt of octyl acid of | 0.4 | 0.4 | 0.4 | 0.4 | 0.4 | 0.4 |
| hardening | | | 1,8-diazobicyclo(5, | | | | | | |
| reaction | | | 4,0) undecen-7 | | | | | | |
| catalyst 1 | | | (DBU) | | | | | | |

| Chlorine + bromine, content (wt %) | 0.0 | 0.0 | 0.0 | 0.0 | 0.0 | same as |
|---|---|---|---|---|---|---|
| Average value (meq/g) of non-saturation degree of polyol | 0.007 | 0.007 | 0.007 | 0.007 | 0.007 | those of |
| Isocyanate index | 105 | 105 | 105 | 105 | 105 | example 1 |
| Volume specific resistance value (at 500 V) | 7.3 | 7.3 | 8.0 | 7.2 | 7.4 | |
| Dependency Δ log₁₀ρᵥ of volume specific resistance value on environment | 0.5 | 0.4 | 0.7 | 0.6 | 0.6 | |
| Compression set (evaluation by using solid specimen) (%) | 3 | 3 | 4 | 3 | 3 | |
| Test for checking stain on photosensitive member | ◯ | ◯ | ◯ | ◯ | ◯ | |
| Hardness | 38 | 38 | 38 | 38 | 38 | |
| <Method of bonding shaft to roller> | Primer for urethane is used | | | | | Treatment |
| | | | | | | with |
| | | | | | | plasma |
| Electric resistance value of roller logR | 5.5 | 5.4 | 7.5 | 5.4 | 5.7 | 5.6 |
| Peripheral nonuniformity of electric resistance of roller | 1.10 | 1.11 | 1.08 | 1.11 | 1.10 | 1.05 |
| Surface roughness Rz(μm) of roller | 6 | 6 | 6 | 7 | 7 | 5 |
| Test for quality of image printed by using developing roller | Δ | Δ | Δ | Δ | Δ | ◯ |
| Test for quality of image printed by using charging roller | ◯ | ◯ | Δ | ◯ | ◯ | ◯ |
| Test for quality of image printed by using transfer roller | ◯ | ◯ | ◯ | ◯ | ◯ | ◯ |

where E denotes example.

TABLE 2

| Chemicals | Commercial name | Maker | Details of chemicals | CE1 | CE2 | E3 |
|---|---|---|---|---|---|---|
| Polyether | | Bayer | Polypropylene glycol(PPG) base, Bifunctional, | | 50 | |
| polyol 1 | | A.G. | Molecular weight: 4000, non-saturation degree: | | | |
| | | | 0.007 meq/g | | | |
| Polyether | | Bayer | PPG base, Trifunctional, Molecular weight: 6000, | | | 50 |
| polyol 2 | | A.G. | non-saturation degree: 0.007 meq/g | | | |
| Polyether | | Sumika | PPG base, Bifunctional, Molecular weight: 4000, | 50 | | 50 |
| polyol 3 | | Bayer | non-saturation degree: 0.048 meq/g, Hydroxyl | | | |
| | | Urethane | value = 28 mgKOH/g | | | |
| Polyether | | Sumika | PPG base, Trifunctional, Molecular weight: 4800, | 50 | 50 | |
| polyol 4 | | Bayer | non-saturation degree: 0.048 meq/g, Hydroxyl | | | |
| | | Urethane | value = 35 mgKOH/g | | | |
| Conductive | Lithium salt of | Sanko | | 0.5 | 0.5 | 0.5 |
| agent 1 | bis(trifluoromethylsulfonyl) | Chemical | | | | |
| | imide | Industry | | | | |
| Conductive | Lithium salt of | Sanko | For single ionization, negative ion adsorbent | | | |
| agent 2 | trifluoromethylsulfonic | Chemical | adsorbs 10% of negative ions | | | |
| | acid | Industry | | | | |
| Conductive | Lithium salt of | Sanko | Used without single ionization | | | |
| agent 3 | trifluoromethylsulfonic | Chemical | | | | |
| | acid | Industry | | | | |
| Isocyanate | SBUisocyanate-0389 | Sumika | Mixture of bifunctional modificated | 8.8 | 8.4 | 8.4 |
| 1 | | Bayer | MDI + polymericMDI | | | |
| | | Urethane | | | | |
| isocyanate | U-CAT SA102 | San-apro | Salt of octyl acid of 1,8-diazobicyclo(5,4,0) | 0.2 | 0.3 | 0.3 |
| hardening | | | undecen-7 (DBU) | | | |
| reaction | | | | | | |
| catalyst 1 | | | | | | |

| Chlorine + bromine, content (wt %) | 0.0 | 0.0 | 0.0 |
|---|---|---|---|
| Average value (meq/g) of non-saturation degree of polyol | 0.048 | 0.028 | 0.028 |
| Isocyanate index | 105 | 105 | 105 |
| Volume specific resistance value (at 500 V) | 7.0 | 7.1 | 7.2 |
| Dependency Δlog₁₀ρᵥ of volume specific resistance value on environment | 0.9 | 0.8 | 0.8 |
| Compression set (evaluation by using solid specimen) (%) | 5 | 4 | 4 |
| Test for checking stain on photosensitive member | X | X | X |
| Hardness | 35 | 36 | 37 |
| <Method of bonding shaft to roller> | Primer for urethane | | |
| | is used | | |
| Electric resistance value of roller logR | 5.2 | 5.3 | 5.4 |
| Peripheral nonuniformity of electric resistance of roller | 1.13 | 1.12 | 1.12 |
| Surface roughness Rz(μm) of roller | 9 | 8 | 7 |
| Test for quality of image printed by using developing roller | Δ | Δ | Δ |
| Test for quality of image printed by using charging roller | Δ | Δ | Δ |
| Test for quality of image printed by using transfer roller | Δ | Δ | Δ |

where CE denotes comparison example.

TABLE 3

| Chemicals | Commercial name | Maker | Details of chemicals | CE4 | CE5 | CE6 |
|---|---|---|---|---|---|---|
| Epichlorohydrin | Epichromer | Daiso | EO:EP(epichlorohydrin): AGE = 56:40:4 | 100 | | |
| rubber | | | | | | |
| Chloroprene rubber | Neoprene WRT | DuPont·Dow·Elastomer | | | | 100 |
| Thermoplastic | Lezamin EC2275 | Dainichiseika Co. | Trial product containing lithium | | 100 | |
| urethane containing | | Ltd. | salt | | | |
| lithium-based | | | | | | |
| conductive agent | | | | | | |
| Carbon | Denka black | Denki Kagaku Kogyo | Acetylene black | 2 | | 22 |
| Synthesized | DHT-4A-2 | Kyowa Chemical | | 3 | | 3 |
| hydrotalcite | | Industry | | | | |
| Zinc oxide | Ginrei R | Toho Aen | | 5 | | 5 |
| Stearic acid | 4931 | Unikema Australia | | 1 | | 1 |
| Vulcanizing agent 1 | Accel 22-S | Kawaguchi Chemical | Ethylene thiourea | 2 | | 2 |
| | | Industry | | | | |
| Vulcanizing | Nocceler | Ouchishinko | Di-ortho-trilguanidine | 1.7 | | |
| accelerator 1 | | Chemical Industry | | | | |

| Chlorine + bromine, content (wt %) | 18.3 | 0.2 | 30.6 |
|---|---|---|---|
| Volume specific resistance value (at 500 V) | 7.6 | 8.2 | 6.7 |
| Dependency Δlog₁₀ρᵥ of volume specific resistance value on environment | 1.0 | 1.4 | 0.1 |
| Compression set (evaluation by using solid specimen) (%) | 3 | 94 | 7 |
| Test for checking stain on photosensitive member | ◯ | ◯ | ◯ |
| Hardness | 47 | 69 | 67 |
| <Method of bonding shaft to roller> | Hot-melt adhesive | | |
| | agent | | |
| Electric resistance value of roller logR | 5.9 | 7.8 | 4.9 |
| Peripheral nonuniformity of electric resistance of roller | 1.10 | 1.21 | 2.20 |
| Surface roughness Rz(μm) of roller | 9 | 11 | 10 |
| Test for quality of image printed by using developing roller | Δ | X | X |
| Test for quality of image printed by using charging roller | ◯ | X | X |
| Test for quality of image printed by using transfer roller | Δ | X | X |

where CE denotes comparison example.

The unit of the numerical values of the components shown in tables 1 through 3 is part by weight.

The conductive agents 1 through 3 were dispersed uniformly in the polyether polyol. The lithium-bis (trifluoromethylsulphonyl)imide (LiN(SO₂CF₃)₂) was prepared by a known method. As the conductive agent 2, the lithium salt of the trifluoromethylsulfonic acid (LiCF₃SO₃) commercially available was used.

A negative ion adsorbent adsorbed 10% of negative ions of the conductive agent 2 to single-ionize the conductive agent 2. The adsorbent was removed after it adsorbed the negative ions. The conductive agent 3 was used without single-ionizing it.

### EXAMPLE 1 THROUGH 6

The polyol consisted of the polyether polyol having a non-saturation degree of not more than 0. 025 milliequivalents/g. The isocyanate, the conductive agents, and the additives were used at the mixing ratios shown in the tables.

The conductive agents were dispersedly dissolved in the polyether polyol. Thereafter a curing catalyst was put into the solution of the conductive agent and the polyether polyol. The solution was stirred to uniformly disperse the curing catalyst therein. The solution and isocyanate were dried respectively by suction drying with a vacuum pump and a desiccator to remove water contained therein.

Both solutions prepared by the above-described method were carefully stirred in a container with a general-purpose stirrer in such a way as not to generate bubbles. After the stirring operation was completed, the mixture of both solutions was cast into a die for forming slab sheets, a die for a conductive roller, and the like, and a die for forming compression set-measuring specimens.

Dies for the developing roller, the charging roller, and the transfer roller were prepared. A metal shaft to be exclusively used for each roller was set in each die in which the mixture of the two solutions had been cast carefully in such a way as not to generate bubbles, after the metal shaft underwent primer (produced by Sumika Bayer Urethane, mixture of Sumijoule 44V20 and SBU polyol 0759 mixed at the ratio of 1:2 in weight ratio) treatment for urethane (examples 1 through 5) or plasma treatment (example 6).

After each die was heated at 80° C. for 30 minutes, the roller and the shaft were removed therefrom. Then the surface of the roller was polished. The axial end of each roller was cut to finish it to a predetermined dimension that will be described in detail later.

### COMPARISON EXAMPLES 1 THROUGH 3

Specimens and rollers of comparison examples 1 through 3 were formed at the mixing ratios shown in the table 2 by using a method similar to that of the examples. As the polyol, the polyether polyol having a non-saturation degree of more than 0.025 milliequivalents/g was used. The average value of the non-saturation degrees of the polyether polyol was set to more than 0.025 milliequivalents/g.

### COMPARISON EXAMPLES 4 AND 6

As shown in table 3, after a mixture of the epichlorohydrin rubber or chloroprene rubber, the zinc oxide, the stearic acid, and other components were kneaded by using an enclosed kneader, the mixture was discharged from the kneader. Thereafter the vulcanizing agent and the vulcanizing accelerator (vulcanizing agent was used in comparison example 6) were added to the discharged mixture. The mixture was kneaded by an open roll.

After the mixture was taken out from the kneader in the form of a ribbon, the mixture was extruded by a roller head extruder to form the mixture into the shape of a sheet. Then the sheet-shaped mixture was put into a die to vulcanize it at 160° C. for an appropriate period of time. Thereby property evaluation slab sheets and specimens were prepared.

The mixture was preformed tubularly by a mono-axial extruder. After the preform was vulcanized at 160° C. for 10 to 70 minutes, a core metal was inserted into the preform and then the surface of the roller was polished. After the roller was cut to a predetermined size, various conductive rollers were formed.

### COMPARISON EXAMPLE 5

Using a pellet composed of the thermoplastic elastomer composition (thermoplastic urethane containing lithium-based conductive agent), the following specimens were formed.

The pellet was molded by an injection molder into slab sheets of 130 mm×130 mm×2 mm and specimens to examine properties of the slab sheets and the specimens in tests including a compression set test specified in JIS K6262 etc. The pellet of the thermoplastic elastomer composition was supplied to a resin extruder to shape it tubularly. After a shaft was inserted into and bonded to the obtained tubular body, the tubular body was cut to a predetermined dimension and polished. Thereby various conductive rollers were formed.

In the comparison examples 4 through 6, the shaft was bonded to the tubular body with a hot-melt adhesive agent (TR-5 (polyamide resin containing carbon black) produced by Wayaku Paint).

The measurement of the following characteristics was made on the slab sheet of each of the examples and the comparison examples prepared as described above. Tables 1 through 3 show the results.

Measurement of Volume Resistivity of Slab Sheet

Slab sheets (130 mm×130 mm×2 mm) were prepared as described above to measure the volume resistivity (volume specific resistance value) of each slab sheet at an applied voltage of 500V, a constant temperature of 23° C., and a constant relative humidity of 55% with a digital ultrahigh resistance meter R-8340A manufactured by Advantest Corporation. Measurement was conducted in accordance with the volume resistivity measuring method specified in JIS K6911. At an applied voltage of 500V, a constant temperature of 10° C., a constant relative humidity of 15% or at a constant temperature of 32.5° C. and a constant relative humidity of 90%, ρᵥ (Ω·cm) of each slab sheet was measured. The dependency Δlog₁₀ρᵥ of the volume resistivity thereof on environment was computed by using an equation shown below: Δlog₁₀ρᵥ=log₁₀ρᵥ (temperature: 10° C., relative humidity: 15%) log₁₀ρᵥ (temperature: 32.5° C., relative humidity: 90%).

Tables 1 through 3 show the volume specific resistance value of each slab sheet and the dependency thereof on environment by common logarithm.

Measurement of Compression Set

The compression set of each specimen was measured at a temperature of 70° C. for 24 hours in accordance with “Permanent set testing for rubber, vulcanized or thermoplastic” specified in JIS K6262.

Test for Examining Stain on Photosensitive Member

The slab sheet of each of the examples and the comparison examples was kept for one week at 32.5° C. and a relative humidity of 90%, with each slab sheet pressed against a photosensitive member set in a cartridge (cartridge type: 4127×) of a laser beam printer of Laser Jet 4050 type produced by Hulet Packard Inc. Thereafter each slab sheet was removed from the photosensitive member. Thereafter, using the photosensitive member, half-tone printing was carried out by the printer accommodating the photosensitive member. Whether or not printed sheets of paper there were stains caused by pollution of photosensitive member was visually checked to make evaluations at the following criterion:

◯: On printed paper (no stain was observed when it was visually checked)

Δ: Low degree of stain (after five or less sheets of paper were printed, stains on the paper were hardly observed and thus no problem in use)

X: High degree of stain (after five or more sheets of paper were printed, stains on the paper could be still recognized visually)

Measurement of Hardness

The hardness of each specimen was measured in accordance with “Method of testing hardness of vulcanized rubber and thermoplastic rubber” specified in JIS K-6253 (durometer hardness test of type A).

Measurement of Peripheral Nonuniformity of Electric Resistance of Roller

The electric resistance value R(Ω) of each roller having the same dimension as that of the developing roller mounted on a laser beam printer (HL1440) manufactured by Brother Industries, Ltd. was measured by a method described below. The value of common logarithm of the electric resistance value R(Ω) was computed. The peripheral nonuniformity of the electric resistance value was also computed and shown in tables.

The dimension of the rubber tube of the roller was as follows: outer diameter: 20 mm, inner diameter (shaft diameter): 10 mm, and length: 235 mm.

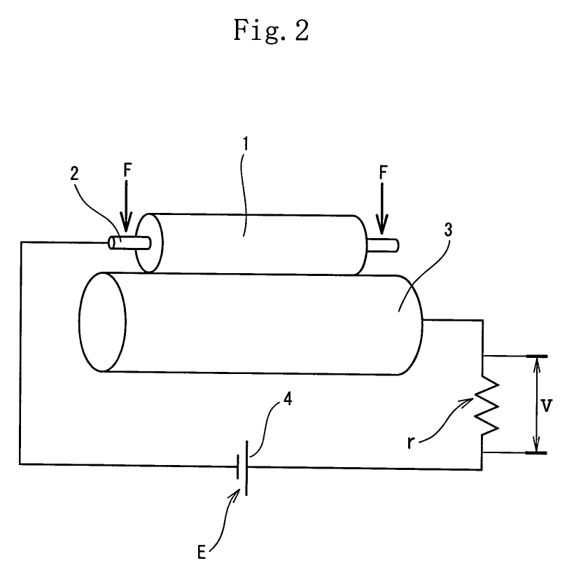

As shown in FIG. 2, to measure peripheral the nonuniformity of the electric resistance of each conductive roller 1, the conductive roller 1 through which a shaft 2 had been inserted was mounted on an aluminum drum 3, with the conductive roller 1 in contact with the aluminum drum 3. The leading end of a conductor, having an internal resistance of r (100 Ω to 10 kΩ: altered in dependence on level of electric resistance value of roller), connected to the positive side of a power source 4 was connected to one end surface of the aluminum drum 3, and the leading end of a conductor connected to the negative side of the power source 4 was connected to one end surface of the conductive roller 1.

A voltage applied to the internal resistance r of the electric wire was detected. The detected voltage was set to V.

Supposing that a voltage applied to the apparatus is E, the electric resistance R of the roller is: R=r×E/(V−r). Because the term of (−r) is regarded as being slight, R=r×E/V A load F of 500 g was applied to both ends of the shaft 2. The roller rotated at 30 rpm. The applied voltage E was 500V. The detected voltage V was measured for 100 rollers during four seconds. The resistance R was computed by using the above equation. The ratio of a computed maximum resistance value to a computed minimum resistance value was set as the peripheral nonuniformity. The measurement was conducted at a constant temperature of 23° C. and a constant relative humidity of 55%.

10-Point Average Surface Roughness Rz (μm) of Peripheral Surface of Roller

The 10-point average surface roughness Rz (μm) of the developing roller defined in JIS B0601 was measured by a surface roughness meter.

The surface roughness Rz (μm) of the peripheral surface of each roller was measured under the condition of the measured length: 2.5 mm; the cut-off: 0.60 mm; and speed (peripheral speed): 0.6 mm/sec. A contact type measuring machine manufactured by Tokyo Seimitsu was used.

As shown in JIS B0601, in a portion extracted from a sectional curve by a reference length, the 10-point average surface roughness (μm) is the difference between an average value of heights of a highest summit through a fifth highest summit measured in a direction of a vertical magnification from a straight line which is parallel with an average line and does not cross the sectional curve and an average value of heights of a deepest ravine bottom through a fifth deepest ravine. The average of the measured values of 10 points was set as the 10-point average surface roughness.

Test for Checking Quality of Image Printed by Using Rollers

Rollers were mounted on each of the laser beam printer (HL1440) manufactured by Brother Industries, Ltd. a color laser printer that will be described below, and a monochrome copying machine. Half-tone images were printed. The copying machine copied orange paper. The printer printed half-tone images formed on a display screen of a personal computer by using various software.

A roller formed in the same size as that of a secondary transfer roller mounted on a color laser printer DP-CL16 manufactured by Panasonic Communications Co., Ltd. was used as the transfer roller in the print-out test.

The dimension of the rubber tube of the transfer roller was as follows: outer diameter: 20 mm, inner diameter (shaft diameter): 8 mm, and length: 221 mm.

A roller formed in the same size as that of a charging roller mounted on a monochrome copying machine IMAGIO MF2730 manufactured by Ricoh was used as the charging roller in the print-out test.

The dimension of the rubber tube of the charging roller was as follows: outer diameter: 14 mm, inner diameter (shaft diameter): 8 mm, and length: 317 mm.

Printed sheets of paper were evaluated on the basis of the following criterion:

◯: Printed image was preferable and thus no problem.

Δ: Low degree of stain on image or disorder of image. Unsuitable for printing a high-quality image such as photograph but no problem in printing character data and the like.

X: High degree of stain on image or disorder of image. Thus cannot be practically used.

As shown in tables 1 through 3, the specimen of each of the examples 1 through 6 composed of the conductive urethane composition contained polyurethane obtained by the poly-addition reaction of the polyether polyol that makes the average value of the non-saturation degree not more than 0.025 milliequivalents/g and the polyisocyanate. Therefore each specimen had the volume specific resistance value as small as 10^{7.2} (Ω·cm) to 10^{8.0} (Ω·cm), the dependency of the volume specific resistance value on environment not more than 0.7, the compression set as small as 3 to 4%, the hardness as small as 38, and did not stain the photosensitive member. Further each roller had a low electric resistance, a low degree in the peripheral nonuniformity of the electric resistance thereof, preferable surface roughness, and a favorable level in the test for evaluating the quality of images printed by using the rollers. Thus, it was confirmed that the rollers could be used suitably as the conductive rollers. The roller of the example 6 treated with plasma had a small surface roughness and was thus excellent as the developing roller. The specimen containing lithium salts of bis(trifluoromethylsulfonyl)imide or lithium salts of trifluoromethylsulfonic acid had a low degree of dependency on environment.

The roller of each of the comparison examples 1 through 3 contained the polyether polyol that makes the average value of the non-saturation degree more than 0.025 milliequivalents/g. Therefore the roller stained the photosensitive member and was hence unsuitable as the conductive roller.

The specimen of the comparison example 4 contained epichlorohydrin rubber as its main component and a large amount of chlorine. Thus when the rollers or the like containing the composition is discarded, there is a fear that a harmful gas or dioxine is generated. Further the specimen had a comparatively high hardness and a high degree of the dependency of the electric resistance value on environment.

The specimen of the comparison example 5 composed of the thermoplastic urethane had a very high compression set and hardness. The specimen had also a high degree of the dependency of the electric resistance value on environment. The specimen of the comparison example 6 contained chloroprene rubber as its main component and had large variations (peripheral nonuniformity) in its electric resistance and a high hardness.

As apparent from the foregoing description, according to the present invention, the conductive urethane composition contains the polyether polyol as the polyol. The average value of the non-saturation degree of the polyether polyol is set to not more than 0.025 milliequivalents/g. Therefore the conductive urethane composition of the present invention has a low electric resistance value, preferable properties (low compression set and hardness), does not stain a photosensitive member. Thus the conductive urethane composition can be suitably used to compose conductive members such as the conductive roller. Therefore the electric resistance value the conductive roller or the like composed of the conductive urethane composition has a low degree of dependency on environment.

By appropriately setting the compression set, the volume resistivity, and the hardness of the conductive urethane composition, it is possible to form the conductive roller that can be suitably used as the transfer roller, the charging roller, the developing roller, and the like. Further the roller composed of the conductive urethane composition has a low electric resistance, a low degree in the peripheral nonuniformity of the electric resistance thereof, allows the electric resistance value thereof to have a low degree of dependency on environment, has preferable surface roughness, and a favorable level in the test for evaluating the quality of images printed by using the conductive rollers composed of the conductive urethane composition. The conductive roller can be used suitably for processes in a color copying machine and the like required to have a comparatively low electric resistance to form a high-quality image.

The addition of even a small amount of the organic ionic-conductive agent realizes a low electric resistance without adversely affecting other properties of the conductive roller or the like and reduces the degree of the dependency of the electric resistance value on environment to a higher extent. By appropriately setting the structure, kind, and mixing amount of the polyether polyol and the polyisocyanate, it is possible to efficiently realize a low electric resistance value and prevent the photosensitive member from being stained.

Further it is possible to bond the peripheral surface of the metal shaft and the inner peripheral surface of the roller to each other with a high adhesive force by treating the peripheral surface of the metal shaft with plasma. Depending on a case, the metal shaft can be mounted on the roller without using an adhesive agent such as a primer. When the adhesive agent such as the primer is not used, it is possible to obtain a roller having a high surface accuracy.

What is claimed is:

1. A conductive urethane composition comprising polyurethane obtained by a poly-addition reaction of polyol and polyisocyanate, wherein polyether polyol is used as said polyol; and an average value of a non-saturation degree of said polyether polyol is set to not more than 0.025 milliequivalents/g.

2. The conductive urethane composition according to claim 1, having a compression set not more than 15% when said compression set is measured at 70° C. for 24 hours in a permanent set testing methods for rubber, vulcanized or thermoplastic specified in JIS K6262; a volume resistivity less than 10^{9.0} (Ω·cm) when said volume resistivity is measured at an applied voltage of 500V in a method specified in JIS K6911; and a hardness not more than 55 degrees when said hardness is measured in accordance with a durometer hardness test type A specified in JIS K-6253.

3. The conductive urethane composition according to claim 1, containing an organic ionic-conductive agent other than ammonium salts containing chlorine or bromine to set said volume resistivity of said conductive urethane composition to not more than 10^{8.0} (Ω·cm).

4. The conductive urethane composition according to claim 3, wherein organometallic salts having fluoro groups and/or sulfonyl groups is contained as said organic ionic-conductive agent.

5. The conductive urethane composition according to claim 4, wherein metal salts of bis(fluoroalkyl-sulfonyl)imide and/or metal salts of fluoroalkyl sulfonic acid is contained as said organometallic salts having said fluoro groups and/or said sulfonyl groups.

6. The conductive urethane composition according to claim 4, wherein not less than 0.5% of said organometallic salt is single-ionized.

7. The conductive urethane composition according to claim 1, wherein said polyether polyol contains ethylene oxide and/or propylene oxide at not less than 50 wt %.

8. The conductive urethane composition according to claim 1, wherein said polyether polyol has polypropylene glycol as a base thereof.

9. The conductive urethane composition according to claim 3, wherein not less than 0.01 parts by weight of said organic ionic-conductive agent nor more than 5.0 parts by weight thereof is used for 100 parts by weight of said polyol.

10. A conductive roller manufactured by preparing a cylindrical body composed of the conductive urethane composition according to claim 1 and by mounting a metal shaft on said cylindrical body.

11. The conductive roller according to claim 10, wherein a peripheral surface of said metal shaft is treated with plasma, and said peripheral surface of said metal shaft and an inner peripheral surface of said cylindrical body are bonded to each other.

12. The conductive roller, according to claim 10, that is used as a charging roller for uniformly charging a photosensitive drum of an electrophotographic apparatus.

13. The conductive roller, according to claim 10, that is used as a developing roller for attaching toner to a photosensitive member of an electrophotographic apparatus.

14. The conductive roller, according to claim 10, that is used a transfer roller for transferring a toner image from a photosensitive member of an electrophotographic apparatus to paper or to an intermediate transfer belt.
